(19) United States
(12) Patent Application Publication
(10) Pub. No.: US 2017/0068679 A1
(43) Pub. Date: Mar. 9, 2017

(54) System and method for assessing and supplementing online content

(71) Applicant: Curiate Technologies Inc., Vancouver (CA)

(72) Inventor: Jennifer Naen Yuan Chen, Surrey (CA)

(21) Appl. No.: 14/845,259

(22) Filed: Sep. 3, 2015

(51) Int. Cl. G06F 17/30

(52) U.S. Cl. CPC G06F 17/3089; G06F 17/30598; G06F 17/30684

(57) ABSTRACT

Online content that would benefit users by being more extensive is searched for, analyzed and supplemented by publishing further relevant content. The content that is searched for includes explicit or implied questions that are unanswered, incompletely answered questions, incorrectly answered questions and content that, if viewed by a user, would trigger questions in the user's mind. The supplementary content is published at the same point as the original content and includes answers to the questions, which may involve, for example, providing information that identifies an item, a character, a building, a location, a place to purchase an item, or whether similar items can be purchased.

### TECHNICAL FIELD

This application relates to posting content online. More specifically, it relates to the assessment of existing content, its analysis and the posting of supplementary related content.

### BACKGROUND

On many occasions, a viewer of a program on television is curious about a prop in the show, such as an item of clothing, a building, a location or other article, and would like to find out what it is, where it is and/or how to obtain it. They may also want to know where similar, more affordable alternative items can be purchased. In other scenarios, a reader of a magazine may want to know what a particular item is in a picture in the magazine. Usually, there is no supporting information that is readily available to identify the object in question. In other situations, people may want to know about the particular location a television clip is filmed in.

People who are interested in knowing about a specific object or place may post a question about it online, in the hope that another user posts a reply. Even if such questions are answered, it is clear that they are sometimes answered without authority or that conflicting answers are provided. In some cases, answers are not specific or actionable enough. The widespread poor quality of answers deters other people from asking the questions that they may have. Some manufacturers, retailers, brands and/or designers have email or social media channels to answer product questions, but finding out exactly who, how or what company one should be talking to in the first place can be difficult.

In cases where users want to answer questions on topics related to their own expertise, there is no way for them to reliably find all the questions they would be interested in answering, especially if those questions consist only of an image and the question, “What's that?”

Before the world wide web, material that was published was usually filtered, reviewed and edited prior to publication. Nowadays, almost anyone can publish almost anything online, without any editorial review, and as such there is a substantial amount of partial or ill-considered content published on the internet. This is a problem specific to the internet.

This background information is provided to reveal information believed by the applicant to be of possible relevance to the present invention. No admission is necessarily intended, nor should be construed, that any of the preceding information constitutes prior art against the present invention.

### SUMMARY OF INVENTION

The present invention is directed to a method and system, which assesses online content and detects questions that are explicit, implicit, or not yet formed about lifestyle and other items as soon as the question-containing or question-triggering content is published. Such detected content may be considered to be content that is lacking. Relevant answers are provided in a timely fashion as supplementary online content in the same medium that the question appeared, allowing the poster of the question or others to take action, or to otherwise benefit from the supplemental information provided. The fact that relevant and high quality answers are provided in a timely fashion in the medium in which they were asked demonstrates to other, potential question-askers that they should indeed ask their questions because there is a higher likelihood that they will be answered.

As disclosed herein, one aspect of the present invention is a method for publishing supplementary online content, comprising: identifying, by a processor, lacking content that is published on a website; formulating, by the processor, supplementary content that supplements the lacking content; and publishing, by the processor, the supplementary content on the website.

Further disclosed is a system for publishing supplementary online content, comprising a processor in a server; and a computer readable media comprising computer readable instructions, which, when executed by the processor, cause the processor to: identify lacking content that is published on a website; formulate supplementary content that supplements the lacking content; and publish the supplementary content on the website.

Still further disclosed is a computer readable media comprising computer readable instructions, which, when executed by a processor, cause the processor to: identify lacking content that is published on a website; formulate supplementary content that supplements the lacking content; and publish the supplementary content on the website.

### BRIEF DESCRIPTION OF DRAWINGS

The following drawings illustrate embodiments of the invention, which should not be construed as restricting the scope of the invention in any way.

FIG. 1 is a schematic diagram of a system for assessing and supplementing online content, according to an exemplary embodiment of the invention.

FIG. 2 is a block diagram showing modules that are present in a server, according to an exemplary embodiment of the invention.

FIG. 3 is a flowchart showing the basic steps taken by the system to assess and supplement online content, in accordance with some implementations of the present invention.

FIG. 4 is a flowchart showing more detailed steps taken by the system to assess and supplement online content, in accordance with some implementations of the present invention.

### DESCRIPTION

### A. Glossary

The term “content” refers to textual, numerical, pictorial, video and/or audio information published on the internet, and may include metadata. Content may in general include information, entertainment, discussions, news, comments etc. that are produced by humans to be consumed by humans. Content does not usually include, for example, advertisements, commercials, sponsorship notices or website navigation bars.

The term “context” may relate to the context in which a user posts a query about something, and may be defined, for example, by the user's preferences, the medium in which the query is made or the user's location. The term may also relate to the context of an item, such as where and when it is being used. For example, an item may be displayed in the context of a television scene, in which case the context of the item may be expressed by metatags of the scene or television series.

The term “firmware” includes, but is not limited to, program code and data used to control and manage the interactions between the various modules and/or components of the system.

The term “hardware” includes, but is not limited to, the physical housing for a computer as well as the display screen, connectors, wiring, circuit boards having processor and memory units, power supply, and other electrical components.

The term “item” refers to a thing or object that users of the system may desire to obtain information about. It can be used, for example, to refer to a location, a building, a product, an article of clothing, a piece of food, a style or artwork in an image or video.

The term “lacking content” refers to content that is deficient in some way, such as missing an answer to a question or missing pertinent information, or content that would benefit consumers by being more extensive or complete.

The term “module” can refer to any component in this invention and to any or all of the features of the invention without limitation. A module may be a software, firmware or hardware module, and may be located in a user device or a server.

The term “network” can include both a mobile network and data network without limiting the terms meaning, and includes the use of wireless (2G, 3G, 4G, WiFi, WiMAX™, Wireless USB (Universal Serial Bus), Zigbee™, Bluetooth™ and satellite), and/or hard wired connections such as internet, ADSL (Asymmetrical Digital Subscriber Line), DSL (Digital Subscriber Line), cable modem, T1, T3, fibre, dial-up modem, television cable, and may include connections to flash memory data cards and/or USB memory sticks where appropriate.

The term “preferences” refers to user-defined features of the invention including settings that are adjustable by users wishing to search for information, or automatically by analysis modules, and can include adjustments made on a real-time basis or based on historical use.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. The processor, if comprised of multiple processors, may have them located together or geographically separate from each other. The term includes virtual processors and machine instances as in cloud computing or local virtualization, which are ultimately grounded in physical processors.

The term “question” includes questions in their literal sense, but when used herein can be broader in that it includes questions that are extracted from content that is not a literal question. Questions could be extracted from content such as a rhetorical statement, a comment about an item, a comment about a place, an image or a video, for example. A question without an answer, or without a correct answer can be considered to be content that is lacking.

The term “server” is used to refer to any computing device, or group of devices, that provide the functions described herein as being provided by one or more servers. If there are multiple constituent servers, they may be geographically co-located or separated.

The term “software” includes, but is not limited to, program code that performs the computations necessary for receiving user inputs, analyzing user inputs and providing outputs, the storage and organization of image related data, displaying information, etc.

The term “system” when used herein refers to a system for assessing and supplementing online content, the system being the subject of the present invention. The system is able to detect online content that would benefit from supplementation, such as unanswered questions and insufficiently described images. The system can formulate additional, relevant content and publish it online.

The term “tag” refers to marking an image or a portion of an image that corresponds to an item in the image. The tag may be visible or invisible, or may be toggled on and off, manually or automatically. It may become visible when the image or frame is touched or tapped, if displayed on a touch screen, or when a cursor is moved onto it or into its vicinity or when a person directs their attention toward or gestures toward a portion of the image. A tag may represent that information about a tagged item is available, or that information about the item has been requested.

The term “user” refers to a person who uses the system or interacts with it via a user device. There may be different types of user, such as a user who wishes to only find out information about item, a user who wishes to provide information about items, or a user who wishes to do both. Users who provide information may be classified into categories depending on their expertise, their amount of experience providing such information to the system, and/or the ratings that other users may grant them. In addition to being the consumer or ultimate audience of an image, users may also be manufacturers, vendors, sales representatives, producers, advertisers, marketeers, owners, etc. Each user may have a reputation that is earned based on his contribution to the knowledge in the system, and each user's contribution may be weighted by his reputation as judged in a variety of ways, including but not limited to accuracy and popularity of contribution.

### B. Exemplary Embodiments

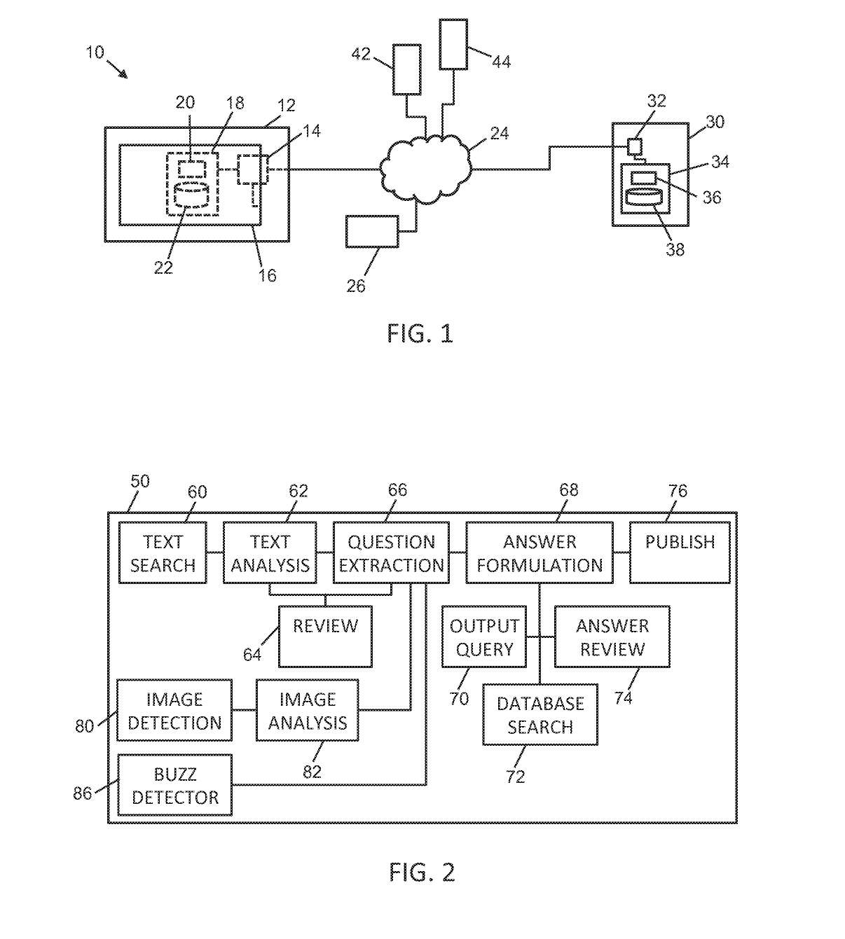

Referring to FIG. 1, an exemplary content assessment and supplementation system 10 is shown. The system 10 includes or interacts with a user computing device 12, which may be a smartphone, a tablet, a laptop, a desktop, goggles, a wrist device, other wearable devices, a gaming machine or any other electronic device that provides the necessary equivalent functionality to fulfill the requirements of the invention. The user device 12 includes one or more processors 14 and a display screen 16, operably connected to the processor(s), which are also operably connected to computer readable memory 18 included in the device. The display screen may be a traditional screen, a touch screen, a projector, an electronic ink display or any other technological device for displaying information. The system 10 includes computer readable instructions 20 stored in the memory 18 and computer readable data 22, also stored in the memory. The memory 18 may be divided into one or more constituent memories, of the same or different types. The user device 12 is connected to or into the system 10 via a network 24, which may, for example, be the internet, a telecommunications network, a local area network or any combination of the foregoing. Other user devices 26 with components functionally equivalent to those of device 12 may also be connected to the system.

The system 10 also includes a server 30, which has one or more processors 32 operably connected to a computer readable memory 34, which stores computer readable instructions 36 and computer readable data 38. The computer readable instructions 20, 36 and computer readable data 22, 38 provide at least part of the functionality of the system 10 when executed or read by the processors 14, 32.

The system 10 also interacts with other servers 42, 44, which are connected to the network 24. Such other servers 42, 44 may have similar or equivalent physical components to the server 30 of the system 10. Such other servers 42, 44 store and make accessible content that is available for access on the user devices 12, 26 for example. This content may include forums, social media, blogs, shared photos, articles, comments on articles, etc. The computer readable instructions and the processors in the servers 42, 44, if connected to or into the system 10, provide the functionality relating to publishing original and supplementary content.

The system is agnostic to format and can work for platforms that are over-the-air, cable, set-top, computer, tablet, phone, camera (e.g. smartphone camera, dash camera, surveillance camera, electronic goggles), DVD, Blu-Ray™ or for downloaded media. It can work with stills, recorded video or live video, as well as images in magazines.

Referring to FIG. 2, the modules 50 present in the memory 18 of an exemplary server 30 are shown.

Text Search module 60 permits the server 30 to search for common patterns in content that is published online, and available, for example, from servers 42, 44. The patterns may be searched in a variety of human languages, and may be simple patterns such as, “What's this?” or “Who makes . . . ?” Question marks may be optional. While this is a naïve example, it captures a large amount of published content that would potentially benefit from supplementary information. As one skilled in the art would know, more complex language patterns can be searched for, in order to reduce the number of false positives that are obtained. The Text Search module 60 is configured to regularly or continually monitor one or more social media, news channels, blogs, online conversations, other sources of online content, etc.

The Text Search module 60 is also used to search for textual patterns that are not literal questions, but which may, after analysis, be deemed to be a question. It may be deemed that the retrieved content would be beneficially more informative and useful to its consumers if supplementary information were added. By later providing supplementary content, which could be an answer to a predetermined question not explicitly present in the content, it could be considered that the retrieved, lacking content is therefore the ‘question’ to which the supplementary content is a response. This can be referred to as pre-emptive answering.

Text Analysis module 62 permits the server 30 to analyze the portions of text that are retrieved by the Text Search module 60. In a simple case, whether the retrieved text matches a given pattern may be sufficient to determine that a question, or lacking content, has been identified. This would be considered a low threshold. In other cases, the extent to which the retrieved text matches the pattern may be used to determine whether a question has been identified or not. Sophisticated natural language processing may also be used in some more elaborate embodiments. Multiple types of intelligence may be used to search for questions, and each could be rated with a confidence level or a score, which may be used to determine whether the result of a search is something that needs to be answered.

The Review module 64 is an optional module that presents the retrieved text to a human, for human review. If the Review module 64 is used in an embodiment, it may be used for all portions of retrieved text or only some of them, and it may be used depending on a score that has been assigned to it by the Text Analysis module 62. For example, text with lower scores, which indicate that the retrieved text is less certain to be a question, either literal or implied, may be directed to the Review module 64. Other text portions, with higher scores indicating that the retrieved text is highly likely to be a question, either literally or implied, may not need to be passed to the Review module 64. The Review module 64, upon receiving retrieved text for review, sends it to one or more of the user devices 12 for display thereon. A response that is received via a user device 12 may be a simple determination that the retrieved text either is or is not a question. In some embodiments, the user of the user device may select from a list of predetermined questions that may be either generic, or generated automatically based on the retrieved, lacking content. In other cases, a user may be able to enter a custom question that is related to the lacking content. When a response has been received, the response is transmitted by the user device 12 to the server 30, for storage in the database 38.

The Question Extraction module 66 formulates one or more questions from the lacking content. The question, when formulated, may be as little as identifying data fields that need to be retrieved from the database 38, should they exist. It may optionally form a grammatically correct question for suitable presentation to a user. A number of preset questions may exist in the module 66, which have blanks that can be automatically be filled in based on the topic of the lacking content. The Question Extraction module 66 may interact with the Review module 64, in cases where a human review of the determined question needs, or is desired, to be verified.

The Answer Formulation module 68 establishes answers to the questions that the Question Extraction module 66 provides. The Answer Formulation module 68 may interact with Output Query module 70, which in turn outputs the question(s) to one or more user devices 12, so that users may provide the answer. The users may be experts in a field that is related to the question, general users forming part of “the crowd”, or staff/agents of the creators of the content (e.g. television, magazine, etc.), or staff/agents who represent the product, item or location (e.g. manufacturer, proprietor, retailer), or paid users that are employed or contracted by the operator of the system 10. Users can opt in or out of these roles. The context of the identified question or lacking content may be analyzed to determine which expert or other user or group of users to transmit the question to. Responses received from the user devices 12 may be analyzed by the Answer Formulation module 68 to determine which is the most appropriate answer. Various differing answers may be rated according to the expertise of the user that supplied it or by a number of votes that an answer received, for example. The Answer Formulation module 68 may consult the Database Search module 72, which looks in the database 38 of stored answers to existing questions. It may be the case that the question that has been identified has already been answered elsewhere and stored in the database 38. In this case, the Output Query module 70 would not need to be used. After an answer has been determined by the Answer Formulation module 68, it may interact with the optional Answer Review module 74, which transmits the extracted question and determined answer to one or more user devices 12 for review by a user. The formulated answers may be queued for human review. The response received may be either an agreement or a disagreement that the answer is correct, and is transmitted back from the user device 12 to the server 30 where it is stored in the database 38.

The Answer Formulation module 68 may also provide links to other questions that have been answered. For example, if a user posted a question about a first item, the system 10 may post an answer about the first item and also post a link to an answer about a second item that is related to the first item. The relation between the two items may be that the items themselves have a feature in common, that they have been used by the same character in a movie, or that other users with profiles or preferences similar to the posting user have been found to like or have purchased both the items. Such links may be sent privately to the user who posted the first question, if they are user-specific, or they may be made public.

The Publish module 76 receives the answer from the Answer Formulation module 68 and posts it to the website from which the question was retrieved, in the format appropriate for the website. The part of the website may be a subset of a social media, a semi-private social media, or it may be an unrestricted social media, for example. Such a post may be a comment in a thread of comments, or may be a response to a single, literal question. It may also be posted to other websites that have similar, lacking content to that which was retrieved, and which has not already been supplemented. It may also be posted on a separate website with other answers that the system 10 has formulated.

The Image Detection module 80 may detect that images have been posted online, with no or minimal supporting information, or even with just an exclamation mark or a heart symbol for example. Such images are ideal candidates for providing supplementary content.

The Image Analysis module 82 analyzes the images retrieved by the Image Detection module 80, to identify discrete objects within the images or to identify that the image is of a building or a location. Such identified objects are passed to the Question Extraction module 66, which is able to formulate questions about the objects using a predefined set of questions, such as “Who makes this?”; “Where can I buy one?” “How much does it cost?”; “Are there similar items that are more affordable?”; etc. If the image is of a location, the question may be “Where is this?” or “How does one get there?”. Again, the results of the Question Extraction module 66 may be passed to the Review module 64 for review by a user.

The Buzz Detector module 86 is used to monitor online content in order to detect topics that are trending. The topics may involve objects and/or locations for which further information may be provided by the system, without there necessarily being any literal questions posted. The output of the Buzz Detector module 86 is fed to the Question Extraction module 66, which identifies potential questions, the answers to which will provide useful, topical supplementary information that can be automatically posted in relation to the subjects that are trending. For example, whether an image is posted due to the poster wondering about the scene or its contents, or whether the poster was approving or disapproving of it, providing supplementary content all goes to popular interest. It may also be the case that the Text Analysis module 62 is used to determine whether there are any potential questions present in the buzz.

A result of the system 10 having modules that can search for and detect questions online, using pattern matching techniques for example, is that many questions can be found that would otherwise go ignored. Such questions could not likely be found using traditional search engines because the search terms that one would want to use would be terms in the answer rather than terms in the question.

The various modules 50 of the system 10 may be used to detect questions for which incomplete and/or wrong answers have been given. By retrieving a more complete and/or correct answer from the database 38, the system 10 can publish valuable supplementary information as an additional response to the question that has not been properly answered. For example, a correct but incomplete answer may indicate the name or the generic type of a product that appears in a video clip, but does not provide information as to where it can be purchased. In this case, the system 10 is able to provide supplementary information that describes where the product can be purchased from, making the answer more detailed and actionable (i.e. making the product more readily purchasable).

Answers that are published may be tailored to the context in which the questions are asked. For example, the answer can be in the same language as the question. If a brick-and-mortar location is part of the answer, it could be selected and provided depending on the location that is the subject of the initially posted content. Links could be provided to location-dependent information so that different users in different locations can obtain the most relevant supplementary information.

Answers published by the system 10 may include recommendations. For example, if users make use of the supplementary content they may have the option to give it a “thumbs up” or other rating.

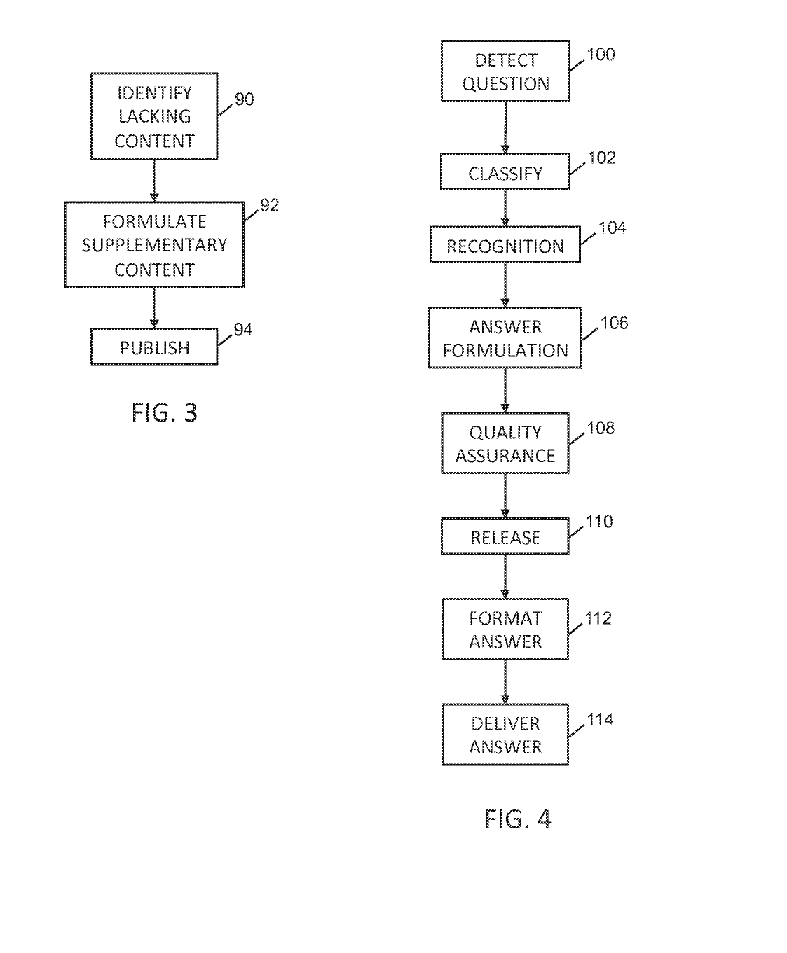

Referring to FIG. 3, a flowchart is shown of the basic steps of the method for assessing and supplementing online content. In step 90, the system 10 identifies online content that is lacking, i.e. content that would benefit its consumers by being supplemented with further information. The content may be lacking only in that it is an unanswered question. In other cases, it may be lacking in that a question has been incompletely or incorrectly answered. It may be lacking in that it has minimal information. Step 90 may be performed by modules 60, 62 for example.

In step 92, the system formulates supplementary content that is relevant to the lacking content, the supplementary content filling at least some of the gaps present in the lacking content. The supplementary content may, for example, be an answer to a question, further information related to the lacking content and/or information about other items that are related to the lacking content. Step 92 may be performed by modules 68, 70 for example.

In step 94, the formulated supplementary content is published to the location where the original, lacking content was published. Step 94 may be performed by module 76. It may additionally be published elsewhere online.

FIG. 4 shows a more detailed flowchart of a process that the system 10 undertakes. In step 100, the system 10 detects a question that has been published online. As stated above, the question may be literal, implied, tangential, nebulous, nascent or as yet unformed. The question may merely be an image that has been posted or an image that has been posted within a context that implies a question. The question may be supplied by a user, detected automatically, or it may be a combination of both. Step 100 may be performed by one or more of modules 60-66 and 80-86. In step 102, the question is classified, for example into questions about bags, questions about shoes, questions about painting, questions about lifestyle items, questions about furniture, questions about buildings, questions about locations, etc. The classification may be made by a user, detected automatically, or it may be a combination of both. Classification may be a function of the Question Extraction module 66.

In step 104, the object or item to which the question related is recognized. In the case of an image that is used to formulate the question, an object in the image is recognized to be one that is already in the database 38. This may be performed by module 72. As a result, the information pertaining to the object can be retrieved and an answer formulated in step 106, which may be performed by module 68. In other cases, the recognition of the object in question can be performed by a user, such as an expert in the field, or the crowd of users in general, via module 70. If recognized by a user, the supplementary information about the object can be supplied by the user in step 106. As above, steps 104 and 106 may be performed by either or both of a user and the system 10.

In step 108, the quality of the formulated answer can be reviewed by a user, or by a group of users via module 74. In other cases, the answer may be reviewed by the system, or it may be reviewed by both the system and a user. If the quality of the answer is acceptable, then the answer is released in step 110, via module 68. In step 112, the answer is formatted, by module 68 of the system 10, for the specific space it is to be published in. In step 114, the system 10 then transmits the properly formatted answer to the corresponding website for it to be published as content that is supplementary to the existing content, which is accomplished by module 76.

Where all the steps are performed by the system 10 in an automated fashion, it is possible for the system to publish supplementary content before a human, other than the poster, has read or observed the existing content. As such, the system 10 can proactively add to the usefulness of online content.

### C. Industrial Applicability

The system is useful to provide information to people who post questions about objects, locations and other items. It is also useful to provide supplementary information that may be useful to users who are curious about an object but who would have a low expectation of their questions being timely answered, or even answered at all, and therefore do not bother to ask them. The system is able to proactively publish additional information at the point where it would be useful, by adding supplementary content to existing content that is somewhat lacking, without anyone actually having to ask for the supplementary content.

The system is also useful in television and movie production, where supplemental information can be automatically added to the video clips or frames by being linked from them by the way of tags, for example. In some cases, advertisers may benefit from additional information automatically provided about their products that appear in images or video footage.

### D. Variations

The present embodiments include the best presently contemplated mode of carrying out the subject matter disclosed and claimed herein. However, variations are possible.

In some cases, comments or other postings that users submit for publication may be reviewed by the system 10 before they are published, so that the supplementary content can be published at the same time as the original content.

Modules described as being in a specific location may be implemented in another location. For example, one or more of the modules described as being present in the server may instead be present in a user device. Where modules have been shown separately, two or more of them may be combined into one, depending on the embodiment chosen. In other embodiments, modules may be divided into constituent modules. Additional modules may be added without departing from the scope of the claimed invention. One or modules may be omitted, again without departing from the scope of the claimed invention.

In general, unless otherwise indicated, singular elements may be in the plural and vice versa with no loss of generality. The use of the masculine can refer to masculine, feminine or both.

Throughout the description, specific details have been set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid-state memories, etc. The methods may alternatively be embodied partly or wholly in specialized computer hardware, such as ASIC or FPGA circuitry.

It will be clear to one having skill in the art that variations to the specific details disclosed herein can be made, resulting in other embodiments that are within the scope of the invention disclosed. Steps in the flowcharts may be performed in a different order, other steps may be added, or one or more may be removed without altering the main function of the system. Flowcharts from different figures may be combined in different ways. Screen shots may show more or less than the examples given herein. All parameters and configurations described herein are examples only and actual values of such depend on the specific embodiment. Accordingly, the scope of the invention is to be construed in accordance with the substance defined by the following claims.

1. A method for publishing supplementary online content, comprising:
identifying, by a processor, lacking content that is published on a website;
formulating, by the processor, supplementary content that supplements the lacking content; and
publishing, by the processor, the supplementary content on the website.

2. The method of claim 1, wherein the lacking content comprises one or both of text and an image.

3. The method of claim 1, further comprising:
searching online, by the processor, for the lacking content on websites that permit users to publish content thereon.

4. The method of claim 3, wherein searching online comprises:
searching on social media;
searching on a blog; or
searching in comments.

5. The method of claim 4, wherein the searching comprises using textual pattern matching.

6. The method of claim 1, further comprising:
identifying the lacking content by determining that the lacking content comprises a literal question.

7. The method of claim 1, further comprising:
identifying the lacking content by determining that the lacking content comprises an implied question.

8. The method of claim 1, further comprising:
identifying the lacking content by determining that the lacking content comprises an incorrectly or incompletely answered question.

9. The method of claim 1, further comprising:
identifying the lacking content by determining that the lacking content should be supplemented.

10. The method of claim 1, further comprising:
identifying the lacking content by determining that the lacking content omits answers to one or more predetermined questions.

11. The method of claim 1, further comprising:
identifying the lacking content by determining that the lacking content is an image of an item that has no supporting text for the item.

12. The method of claim 1, further comprising:
formulating the supplementary content by accessing a database of stored information relating to the lacking content.

13. The method of claim 1, further comprising:
formulating the supplementary content according to a context of the lacking content.

14. The method of claim 1, wherein formulating the supplementary content comprises:
transmitting the lacking content or a question based upon the lacking content to a user device; and
receiving an answer from the user device.

15. The method of claim 14, further comprising:
searching online, by the processor, for the lacking content on websites that permit users to publish content thereon;
searching online, by the processor, for further lacking content on said websites;
transmitting further lacking content or a further question based on the further lacking content to the user device; and
receiving a further answer from the user device;
wherein the further lacking content has a context similar to the lacking content.

16. The method of claim 1, wherein the publishing comprises:
publishing the supplementary content in a format appropriate for the website.

17. The method of claim 16, comprising, prior to the publishing:
transmitting the supplementary content to a user device for review by a user; and
receiving, from the user device, an approval for the supplementary content to be published.

18. The method of claim 16, further comprising:
publishing a link with the supplementary content, the link leading to further supplementary content that is related to the supplementary content.

19. A system for publishing supplementary online content, comprising
a processor in a server; and
a computer readable media comprising computer readable instructions, which,
when executed by the processor, cause the processor to:
identify lacking content that is published on a website;
formulate supplementary content that supplements the lacking content; and
publish the supplementary content on the website.

20. A computer readable media comprising computer readable instructions, which,
when executed by a processor, cause the processor to:
identify lacking content that is published on a website;
formulate supplementary content that supplements the lacking content; and
publish the supplementary content on the website.
